(19) United States
(12) Patent Application Publication
(10) Pub. No.: US 2002/0010627 A1
(43) Pub. Date: Jan. 24, 2002

(54) System and method for creation, distribution, exchange, redemption and tracking of digitally signed electronic coupons

(76) Inventor: Gilles Lerat, Paris (FR)

Correspondence Address: Schnader Harrison Segal & Lewis, 1600 Market Street, 36th Floor, Philadelphia, PA, 19103, US

(21) Appl. No.: 09/858,815

(22) Filed: May 16, 2001

Related U.S. Application Data
(60) Provisional application No. 60/204,653, filed on May 17, 2000.

(51) Int. Cl. G06F 17/60

(52) U.S. Cl. 705/14

(57) ABSTRACT

This invention refers to a means to generate, distribute, exchange, verify and redeem coupons in a public network environment, such as the Internet. This provides a safe way to create and distribute coupons from a Manufacturer to one or more Retailers, while at the same time giving the user all information corresponding to the coupon features.

### BACKGROUND OF THE INVENTION

1. Field of the Invention

This invention refers to a means to generate, distribute, exchange, verify and redeem coupons in a public network environment, such as the Internet. This provides a safe way to create and distribute coupons from a Manufacturer to one or more Retailers, while at the same time giving the user all information corresponding to the coupon features.

2. Prior Art

Discount coupons come from the real world. They have been used for decades by retail centers to attract consumers. They are typically distributed in the form of advertisements that have to be cut out by users and taken to the store.

With the coming of the Internet as a major commercial distribution system, the coupon model is being exported to the Internet. A number of Web sites are being established with the purpose of providing Internet users with a way to get reductions coupons for Internet stores or for physical retail centers. Either way, most coupons are in fact images that must be printed from the user's printer, then sent via postal mail; just like in the real world.

Some “virtual coupons” are, in fact, email messages sent to a user's mailbox. To take advantage of the offer, the user has to go to the URL that is referenced in the coupon. In some specific cases, the user is required to give a password to provide proof of his right to get the reduction associated with the coupon.

In the first case (when coupons are printed), it makes them hardly usable for purchasing online. Since the coupon must first be sent via postal mail, it is impossible to buy and take advantage of the offer at the same time.

In the latter case, there is no easy way to make sure that the user who redeems a coupon, is the one who received that coupon in the first place. With systems using passwords, the user has to remember every password associated with the Digital Coupon. Besides, there is no standard way to inform the user of the validity period of the coupon. It must be written somewhere in the message.

Some methods do exist to implement coupons systems in a network environment. Couponing on the Internet has moved from clickable images, password protected discounts and finally transfer of information allowing a server (the Coupon Server) to recognize a client (the Internet user).

A clickable image points to a page from the Merchant Server that immediately proposes the discount. The client is expected to buy from the moment he sees the advertisement. There is no information that is saved on the client side to remind him of the discount.

The password protected discount focuses on knowledge, rather than possession.

A message is sent to users by email or other means of communication. The message contains a description of the discount and a password used as an authentication means that is to be written at checkout on a virtual store in order to get the corresponding price reduction.

In particular, some of these methods consist of data being transferred from a coupon server to a client. However, there is currently no system that truly implements all the functionality of a real world couponing environment. In particular:

All the information related to the coupon (i.e. date of beginning and end of validity, nature and amount of discount, descriptions of the products) is not included in the data being transferred from the Coupon Server to the client.

It is not possible for a manufacturer to issue digital coupons and have other retailers accept them at redemption while still controlling in real time the flow of redeemed coupons.

It would accordingly be advantageous to provide a system to answer these needs so that:

Users get to know all information they need about coupons, digital coupons value can be easily evaluated, and coupons themselves can be exchanged among users.

Manufacturers can create and finance coupons related to their products. Such coupons will be accepted by Digital Merchants (i.e., Retailers) already proposing their products. Manufacturers will approve the redemption of every Digital Coupon, and get information about their Retailers performance. The Manufacturer gets the assurance that coupons cannot be forged.

To obtain a visual description of the discount, in the form of an image embedded in the coupon.

It would also be advantageous to provide innovations pertaining to the digital nature of the medium being used:

Uniqueness of every user: making sure that every user has a unique Identifier.

Uniqueness of every coupon created: making sure that two coupons generated have two different Serial Numbers. Redeemed Coupons will be accepted on a first come, first served basis.

Traceability of coupons: getting to know who download the coupons and who redeems them, on the basis of the user's Identifier.

Flexibility of discounting rules: allowing the Manufacturer to create a coupon whose characteristics vary over time (or any other parameters), such as a Digital Coupon whose value decreases over time.

### BRIEF DESCRIPTION OF THE DRAWINGS

FIG. 1 is a schematic representation of procedures and interaction between a digital coupon book, a digital coupon server and a digital coupon manager.

FIG. 2 is a schematic representation of the steps utilized for creation of a client account.

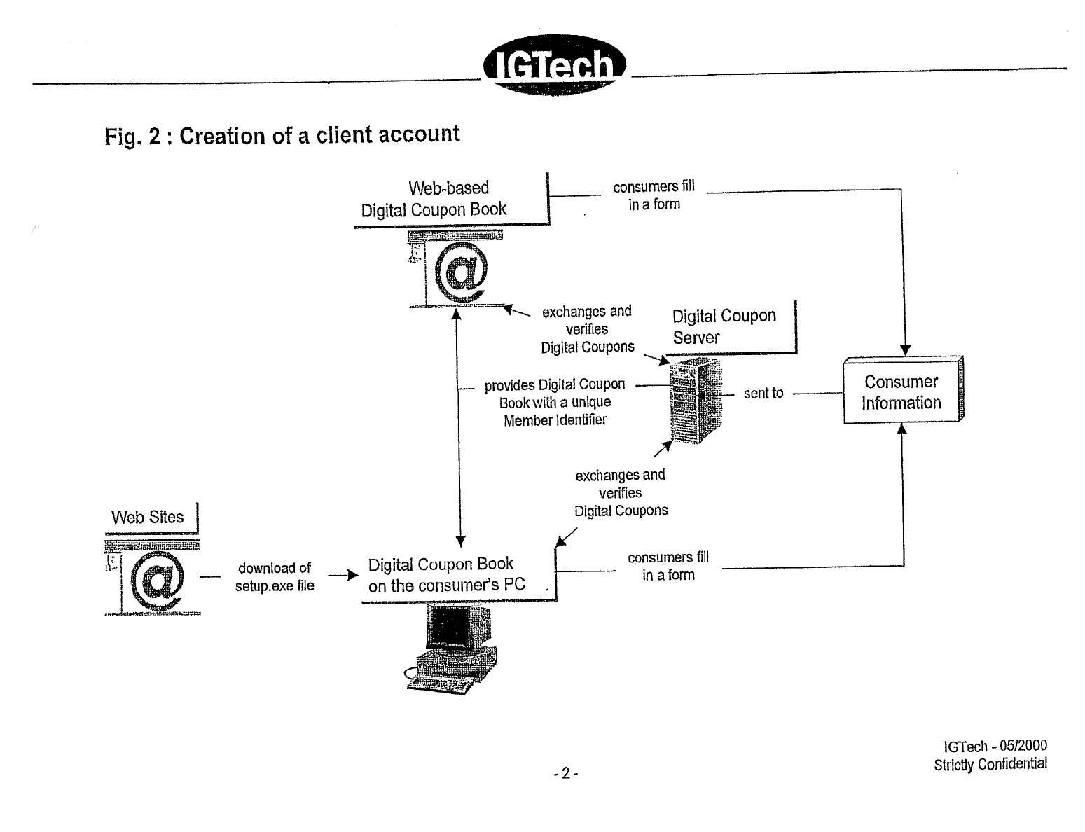

FIG. 3 is a schematic representation of the steps for setting up a merchant system.

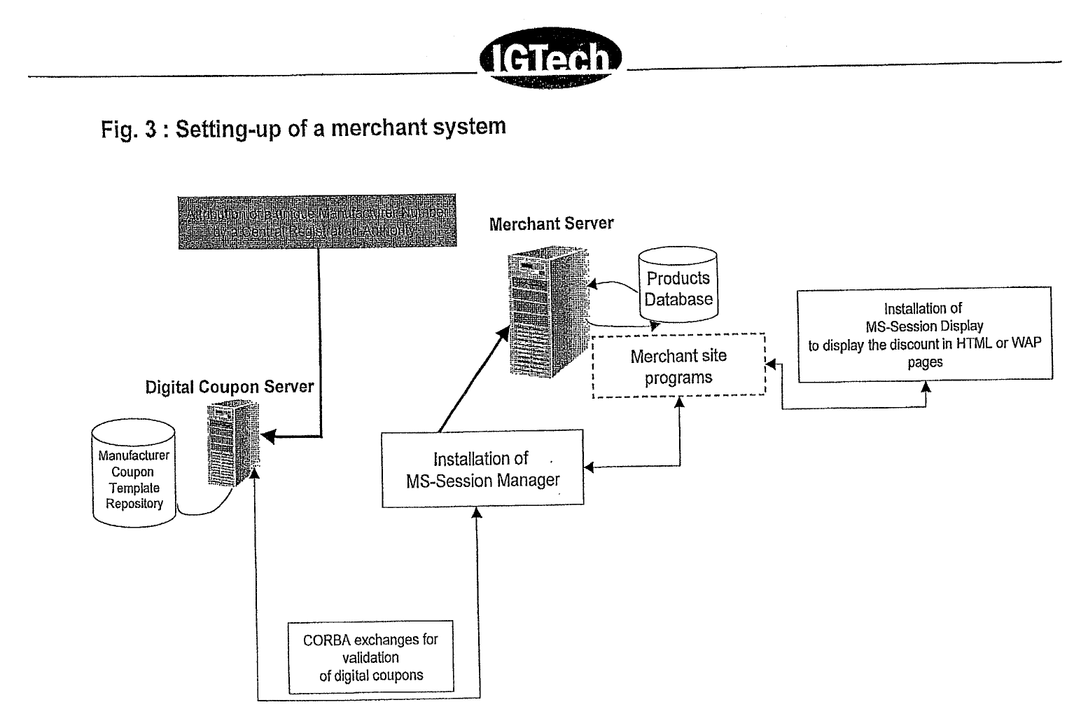

FIG. 4 is a schematic representation of the steps for creating a digital coupon template.

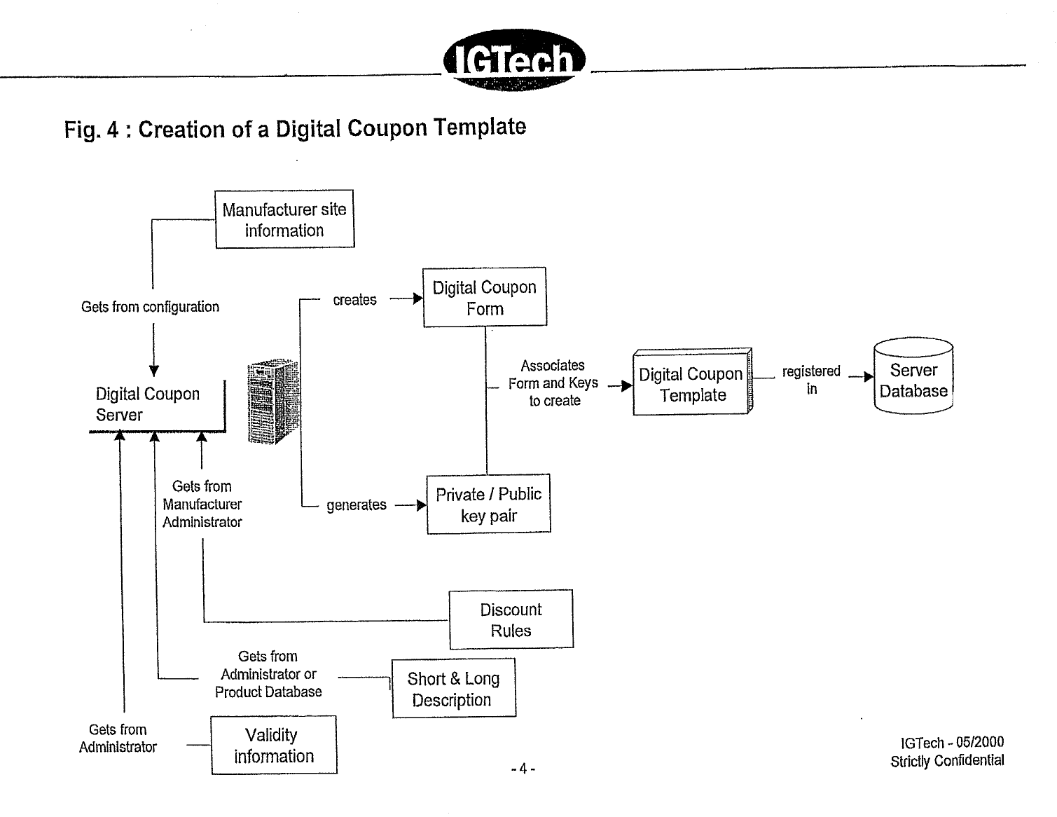

FIG. 5 is a schematic representation of the format of a digital coupon.

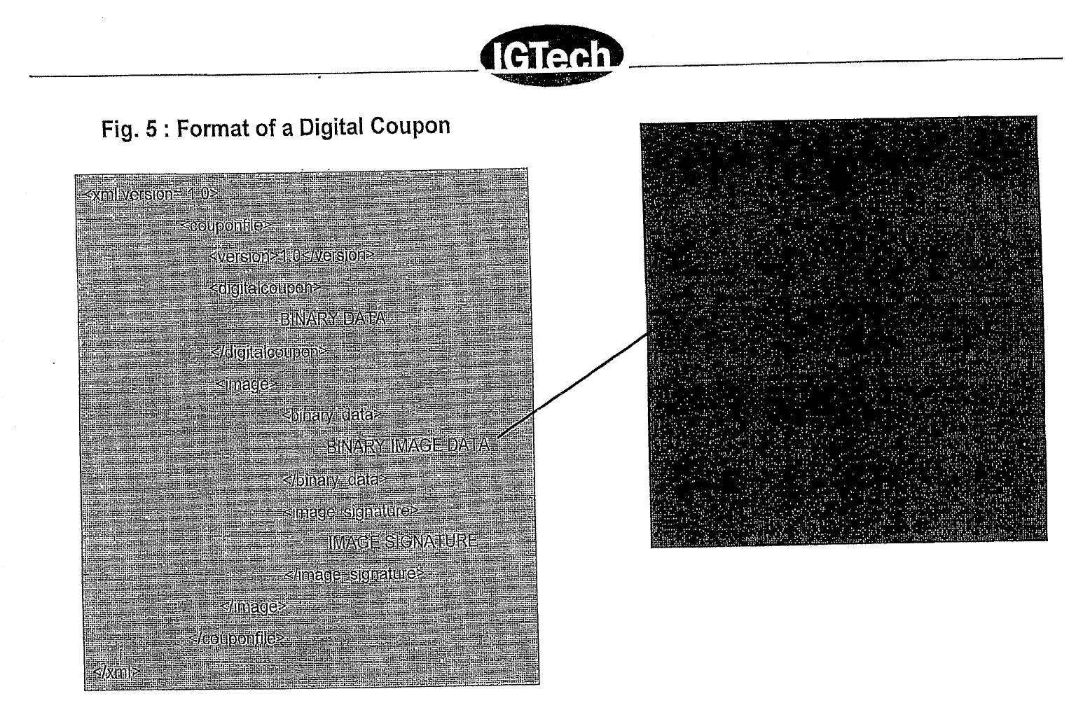

FIG. 6 is a schematic representation of the method for transferring a digital coupon template from a manufacturer to retailer(s).

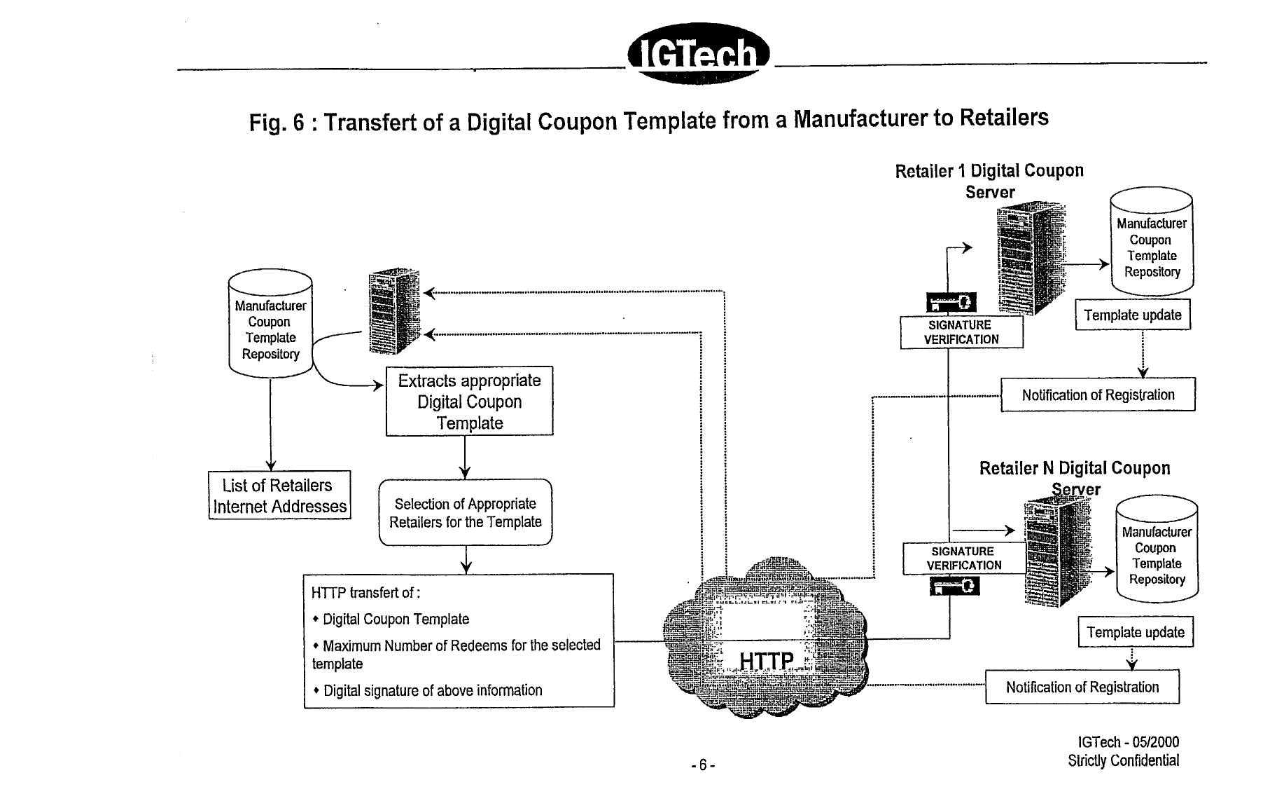

FIG. 7 is a schematic representation of a method for transferring a digital coupon template to a directory.

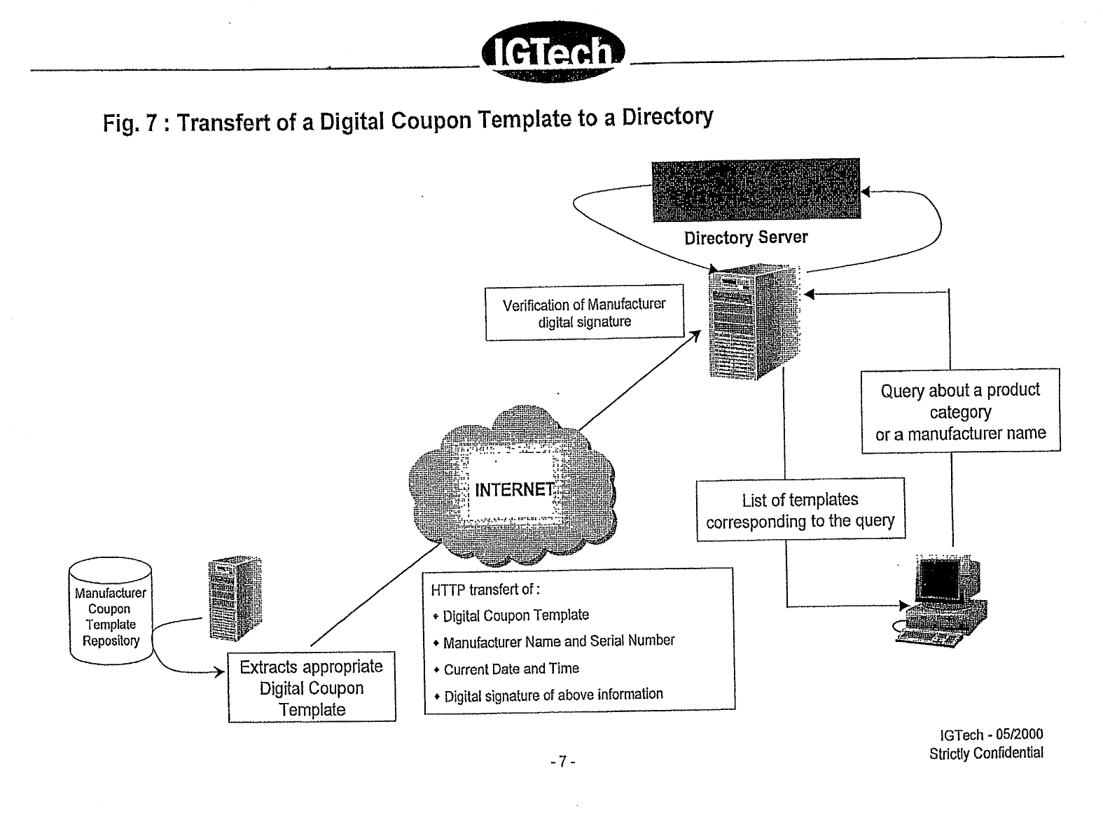

FIG. 8 is a flow diagram of the downloading of a digital coupon by a user or client.

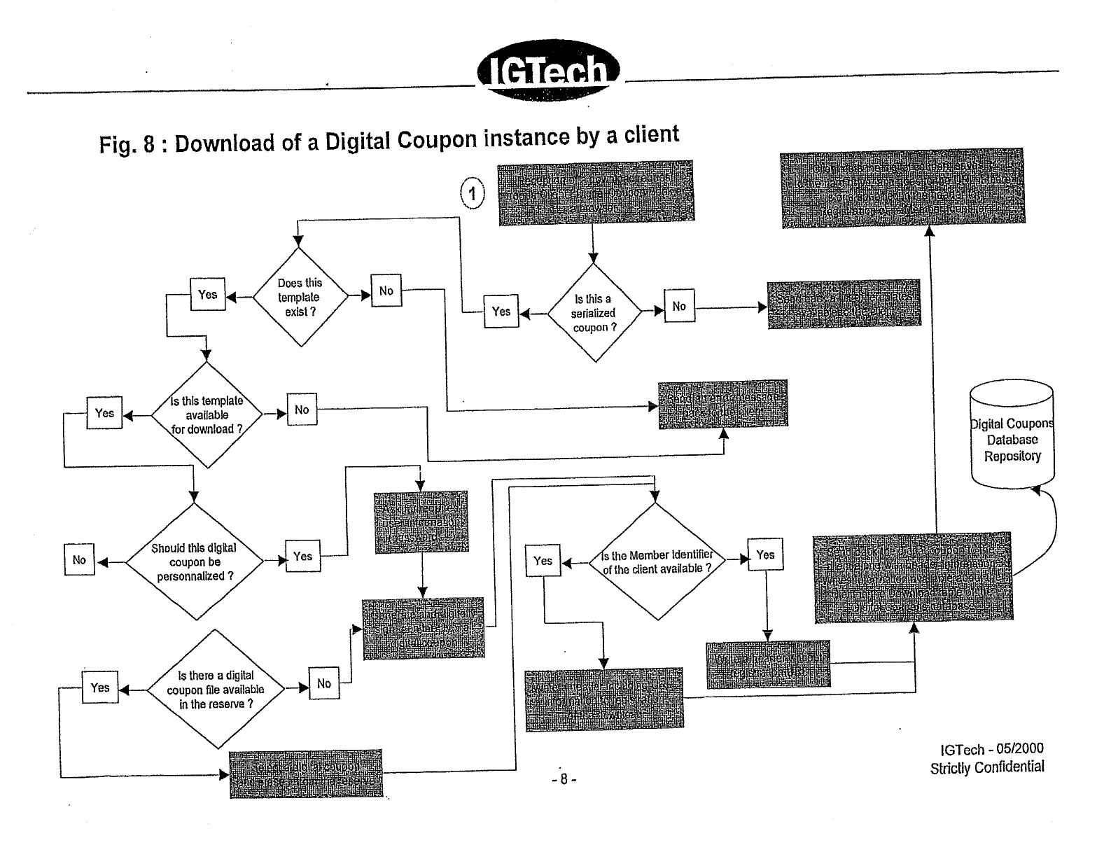

FIG. 9 is a schematic representation of the steps for manipulating a digital coupon by the client/user.

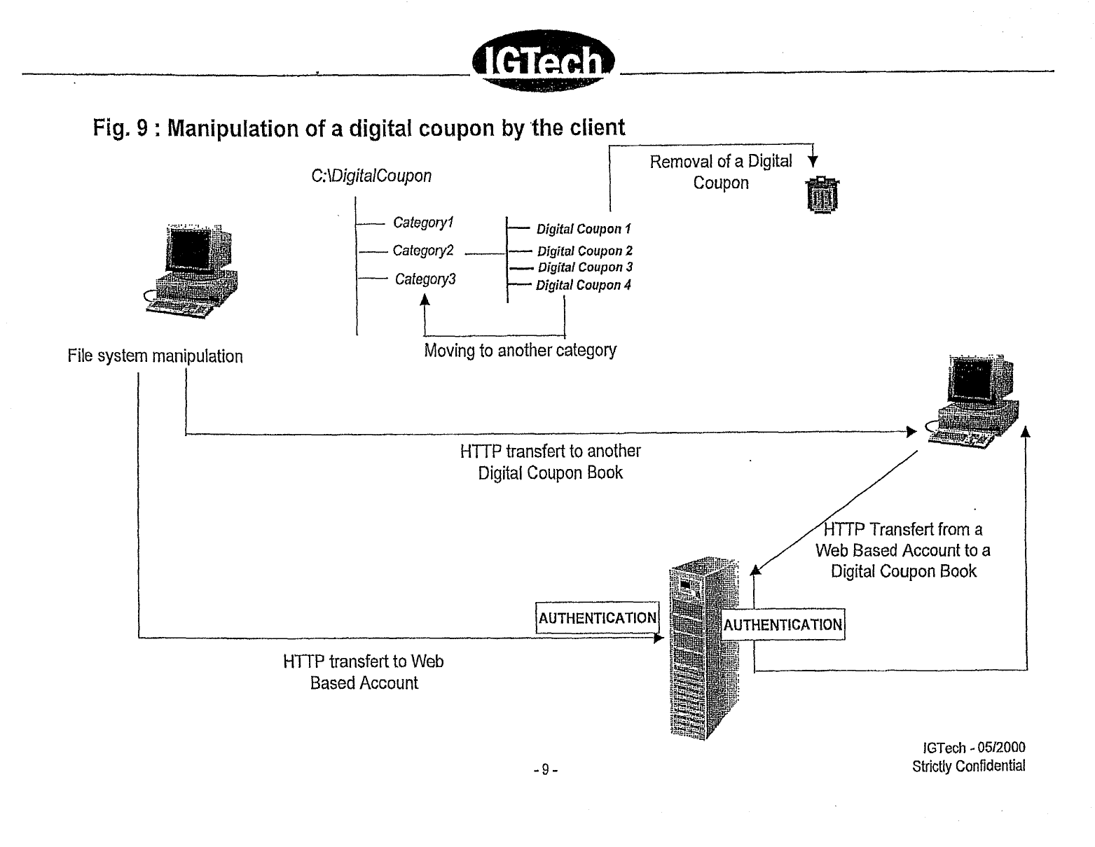

FIG. 10 is a flow diagram illustrating the steps for redeeming a digital coupon.

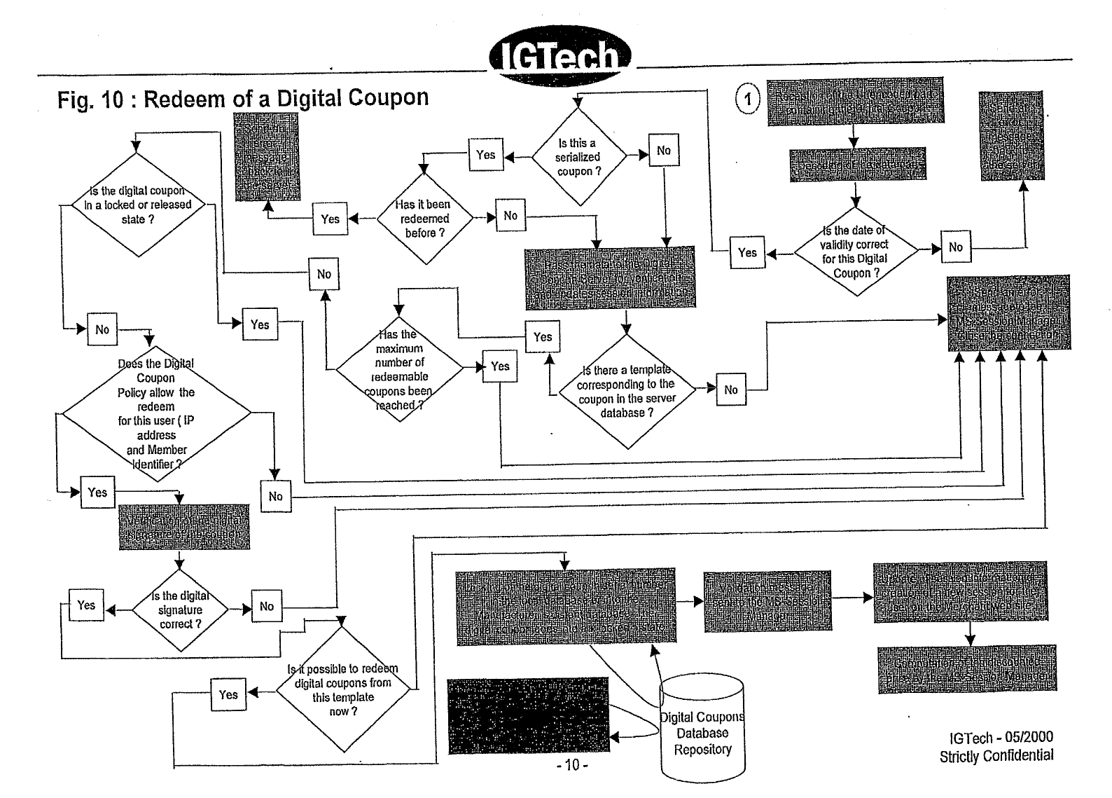

FIG. 11 is a flow diagram outlining the buy-out process during a redemption session.

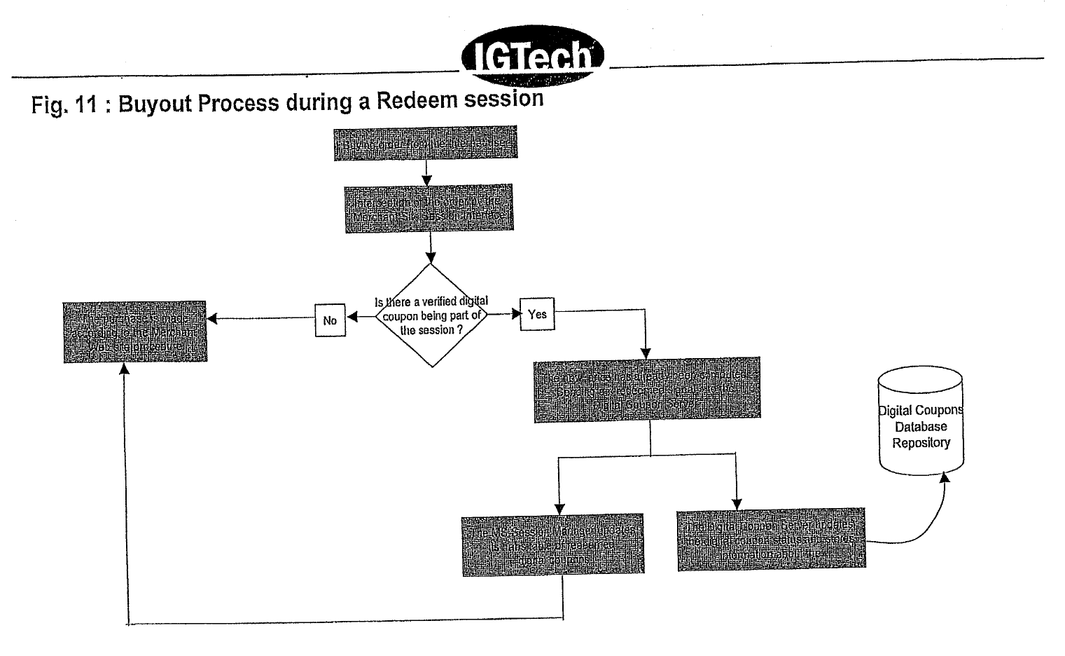

FIG. 12 is a schematic representation for analysis of session information.

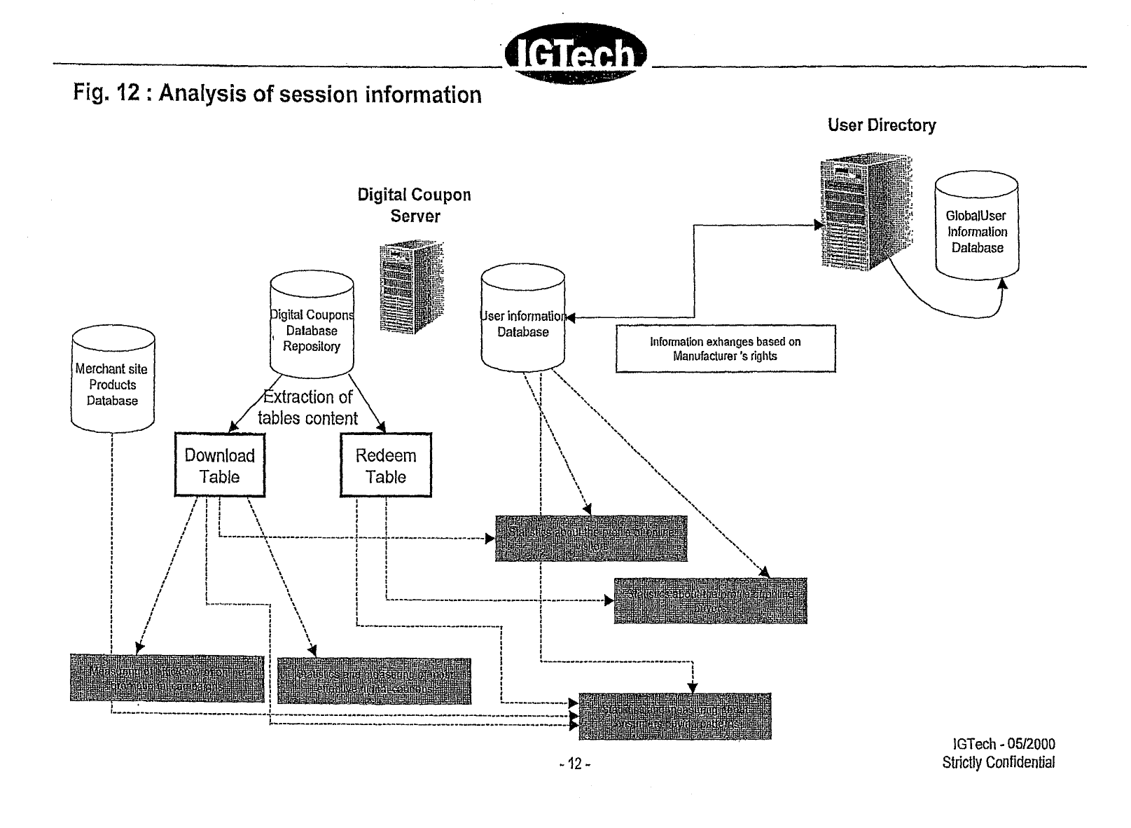

### SUMMARY OF THE INVENTION

This invention relates to a method to create and sign digital representations of uniquely identified coupons for a plurality of users including providing a digital coupon having a serial number, information about a manufacturer, a date of start of validity, a date of end of validity, specific location information for redemption, association with a product or a range of products, information about the product being discounted, discount rules including, but not limited to, amount, currency and type of discount; and embedding a digital signature in the coupon.

This invention also relates to a method of distributing Digital Coupons over the Internet or over any network using a client and server mechanism including generating a coupon file, signing the digital coupon file; and send the digital coupon to a selected recipient through an Internet protocol.

This invention further relates to a method for a user to verify integrity and validity of a selected Digital Coupon at any selected time including presenting to a server responsible for digital Coupon information relevant to price reduction, obtaining a confirmation of validity; generating an error message by the server; and sending the error message to the recipient if the Digital Coupon is not valid.

This invention also relates to a method for a user to redeem a Digital Coupon at a desired moment of a buying process including verifying by a coupon server validity of a specific coupon, storing information regarding said Digital Coupon in a database, subtracting a price of an item being ordered from the discount specified in the Digital Coupon; and generating an order regarding the purchase made by the user.

### DETAILED DESCRIPTION

It will be appreciated that the following description is intended to refer to specific embodiments of the invention selected for illustration in the drawings and is not intended to define or limit the invention, other than in the appended claims.

Interaction Between Entities

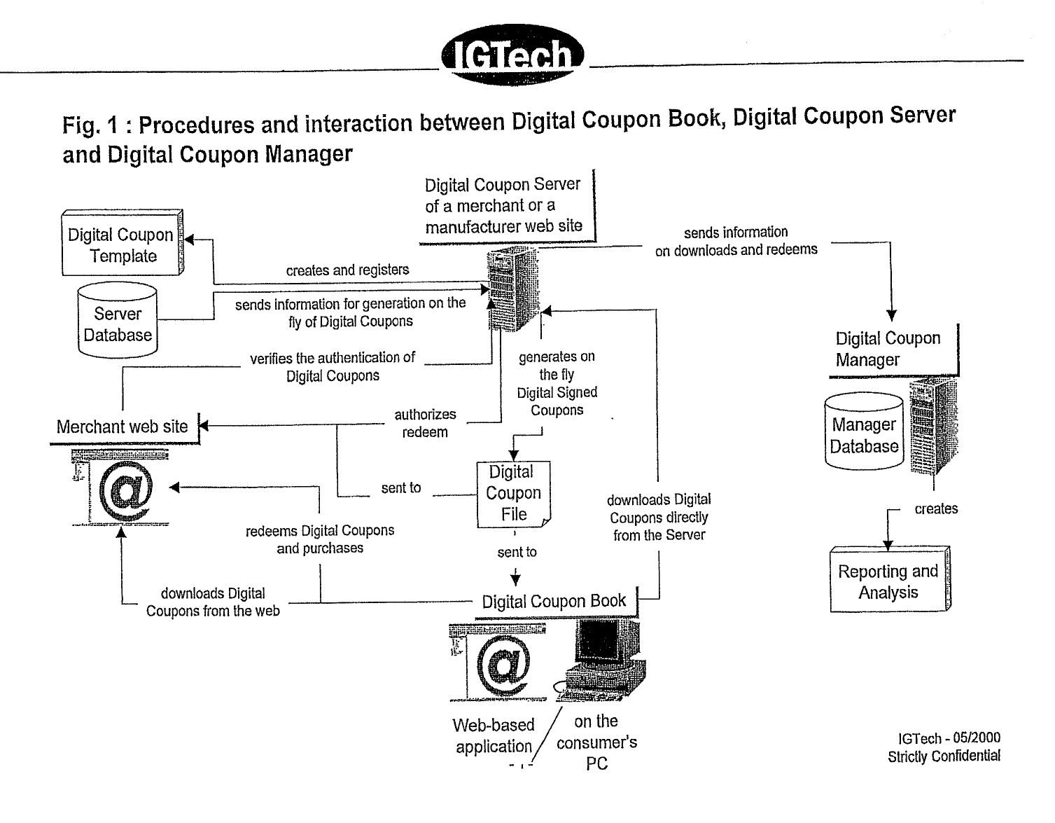

A system for the creation, distribution and redemption of digital coupons is represented in FIG. 1. In a preferred embodiment, the Client system consists of a personal computer or a mobile phone or any Web-enabled device.

A specific application, containing all users digital coupons, is on the client side.

This will be referred to as the Digital Coupon Book (DCB).

The Digital Coupon Server (DCS) refers to software dedicated to digital coupon template creation and storage in a database, digital coupon creation and transfer at a client's request.

The Digital Coupon Manager (DCM) refers to software capable of computing coupons downloaded and redeemed, gathering statistical data which is displayed in the form of graphs. It is also capable of analyzing buying patterns among users of digital coupons and to propose a coupon policy taking advantage of best downloaded and redeemed information.

On the merchant site, the system is capable of getting results from the Digital Coupon Server and to modify the price of products bought by the client accordingly. It interacts with the merchant server software through whatever means is used to keep the context of a buying session, such as cookies or a session ID kept in hidden fields of a form. We refer to this specific application as the “Merchant Site-Session Manager.”

In the scope of this invention, we will refer to the “Manufacturer” as the entity in charge of coupon creation, and in charge of financing the discount applied with the digital coupon.

The Retailer is referred to as the entity to which Digital Coupons are redeemed.

The Manufacturer and the Retailer may refer to the same entity. However, this is not a mandatory condition.

Coupon Characteristics

A digital coupon is defined as a set of data describing features of the coupon such as date of start and end of validity, a unique identifier, and a means to prevent forgery of any part of the data. The coupon can also contain an image, which is extracted and displayed by appropriate software.

The preferred embodiment of a digital coupon system makes use of a digital signature, such as RSA or DSS.

In this embodiment, the coupon is a digitally signed file containing information about the Manufacturer (the entity that creates the digital coupon), the retailers (the entities that accepts coupons created by the Manufacturer), information about the discount type and nature, discount rules applied to a set of items.

Valid coupons are recognized with a common extension to their name such as .cpn.

Valid coupons are associated with a MIME extension, such as application/x-ca-digitalcoupon to allow for specific processing by appropriate software (for example, a browser or a client email application).

Information relevant to a digital coupon contains but is not limited to:

Name of the coupon: describes in human readable form what the coupon is about.

Serial number: uniquely identify and track the coupon.

If a same digital coupon can be redeemed successfully by several users, then the digital coupon is called “non-serialized”, which indicates that the serial number is not verified at redemption.

Beginning of validity period: the period from which the digital coupon can be redeemed.

End of validity period: the period from which the digital coupon cannot be redeemed anymore.

The validity period for a digital coupon can be as short as a few hours or even less.

Issuing Authority: the name of the online Manufacturer.

Short description: a short description of the product(s) being discounted or any aspect related to the coupon.

Long description: a longer description of the products or any aspect related to the coupon.

Discount rules: describes the main characteristics of the coupon, such as the corresponding discounted items identifiers, the type (for example, percentage or nominal) and amount of the discount.

It is possible to specify that the value of the discount will be degressive based on the available “time to live” of the coupon, or other information.

Image: a digital coupon may contain an image, representation of the coupon, that can be displayed with a common image viewer application.

Public Key: the public key corresponding to the private key used to sign the coupon.

Digital Signature of the image: the image is digitally signed using the same private key as the one used to sign the data part. This functionality allows for the image and data to be treated as two independent parts. Upon redemption of a digital coupon, only the data parts need to be exchanged between the client and the server.

Digital Signature: the digital signature is the result of the encryption of a hash of all the data contained in the file (with the exclusion of the image, which has its own signature) with the private key stored on the Manufacturer's database. The hash algorithm may be MD5 or SHA-1.

The Digital Coupon may also contain additional information about the user (such as an email address and a password), which allows more personalization for each coupon. In this case, the coupon is created on the fly for each request by an Internet user.

Other types of information relating to the user's preferences and tastes can be written in the coupon as well.

User Account Creation

In a preferred embodiment, users of the digital coupon system register to an online system. At registration, characteristics of the users are stored in an online database and a unique serial number (a “Member Identifier”) is given to each user.

In this embodiment, a central Registration Authority is given the task of attribution of members identifiers.

The database is used to keep track of user's registration, regardless of the user's way to store it coupons, whether they are kept on a user through a web-based system or with a dedicated application on a client machine.

This serial number will be sent back to the coupon server for every download request and every redemption request, which allows for the server to keep track in a database of downloads and redemptions by each user, and to gather statistical data.

From this information, an analysis tool, the coupon management server will be able to analyze the shopping habits of the consumer.

In an alternate embodiment, no previous registration from the user is needed and it is possible for anybody to obtain and redeem coupons using various means (including a browser such as Internet Explorer or Netscape) and store them on a local computer such as a PC or on a remote store location. No indication as to the user's pattern is passed on to the servers.

Coupon Creation

Coupon creation and distribution to end users can be performed by a single entity, or by an entity (the Manufacturer) for use by other entities (Retailers) with which prior commercial agreements have been set up.

In a preferred embodiment, the creation of digital coupons includes software, the digital coupon server which is able to produce a template of a digital coupon features, that will then be stored in a database.

During digital coupon creation, aspects relating to the description of the coupon are gathered using such graphical interface as a Web browser. A public/private key pair is generated as well as a template serial number (SNTemplate) for every template of a digital coupon.

All this information is stored on a database, the SNTemplate serving as a unique identifier. This allows for dynamic creation of Digital Coupons at download, which gives the possibility to incorporate data coming from the user (such as a password) and a unique serial number.

A method ensures digital coupon serial number uniqueness among all digital coupons issuers.

The digital coupon serial number format results from a concatenation of the digital coupon Manufacturer Number (SNManufacturer), the digital coupon template number (SNTemplate), and the digital coupon rank (SNRank).

Uniqueness among SNManufacturer numbers is guaranteed by a central issuing Authority. It is, therefore, the role of a Root Coordination System to make sure that no two Manufacturers share the same number.

The Root Coordination System hosts tables associating Manufacturers numbers with their corresponding identity.

Uniqueness of SNTemplates is guaranteed within a Manufacturer Digital Coupon Server system. The central repository database of all digital coupons templates keeps tracks of all numbers previously issued. New SNTemplates numbers are computed from an increment of the last issued SNTemplates.

Uniqueness of a given SNRank is the role of the Digital Coupon creation mechanism.

In an embodiment of the system, a procedure is provided making use of an exclusive semaphore through the use of shared memory to give a unique SNRank, for each digital coupon issued.

In one embodiment of the invention, digital coupons are non serialized: the serial number and, thus, the whole coupon file stays the same (by convention, the serial number can end with 0000).

A coupon file is generated and served to at the user's request.

This sort of coupon is not trackable, but it is more suited for distribution over several distribution networks (such as a floppy disk, or a CD-ROM).

If the digital coupon is to be distributed to more than one user using any non-network means, then this digital coupon has to be valid for several users. This is where the concept of a non-serialized digital coupon gets useful.

In another alternate embodiment, digital coupon serial numbers are verified at redemption and, thus, each digital coupon is unique.

A first practical solution to this problem is to generate digital coupon files and sign them at the user's request, that is to say, in real time.

This also allows for better personalization of digital coupons, since it is possible, if the template specifies it, to incorporate data coming from the client requesting the coupon.

Another alternative is to generate digital coupon files in advance.

Digital coupon files created this way are stored under the directory name of their corresponding template, which makes digital coupon retrieval faster.

This mode does not allow for personalization. It does, however, increase download speed, since coupons are generated files, and can then be delivered as static content, such as HTML pages.

It is possible for the creator of the coupon template to specify a balance between coupons created on the fly, and coupons stored in advance for faster download. The proportions can be determined through an administration server.

Information specified by the Administrator includes, but is not limited to, all aspects specified during the definition of a coupon format.

The Redeem URL is transmitted by Retailers and written down for the digital coupon template.

It is the administrator's responsibility to specify the behavior of the download policy, in particular:

The maximum number of downloadable coupons: indicates the maximum number of digital coupons that will be served to Internet users.

The maximum number of redeemable coupons: indicates the maximum number of digital coupons that will be accepted at redemption.

It is possible to set 2 different values for both.

Whether the coupons should be redeemed by the same user that downloaded the coupons.

In a preferred embodiment, the user's Member Identifier is captured during the download and redemption process. It is, therefore, possible at redemption to make a comparison between the two numbers on the basis of the digital coupon serial number.

Information regarding the gross margin made by selling the product may also be written during the creation of the digital coupon template. While this information is not useful for the digital coupon itself, it is usable later by the Digital Coupon Manager.

Other types of information (such as the marketing budget devoted to promoting this online campaign) may be written as well.

Digital coupons may be associated with keywords, the corresponding information being registered in the database: digital coupons will then be searchable at the user's request.

In a specific part of the embodiment, the administrator of the coupon server can ask to be warned by email or any other network protocol (such as SNMP) when the number of downloaded digital coupons reaches the limit as set during the creation.

A specific flag, the “status flag”, is also set up as part of the creation of the digital coupon template. This status flag can be changed at any time by the Merchant Administrator to block the redemption or download process. This status flag is also changed automatically by the digital coupon server system for various reasons such as if the maximum number of digital coupons has already been redeemed.

Coupon Distribution to Retailers and Directories

One of the prerequisites to exchanging digital coupons between a Manufacturer and several Retailers is that all entities use a dedicated software for transferring and validating the flow of information being exchanged.

In a preferred embodiment, a dedicated protocol such as IIOP is used to transfer and validate information from a Manufacturer to selected Retailers.

The integrity of the information being transferred is maintained through the use of digital signatures. The information being exchanged is encrypted using the Manufacturer private key.

The information is easily authenticated by all Manufacturers having registered with the public key.

The public key of the manufacturer needs to be exchanged and verified between the Manufacturer and selected Retailers by a non-network means such as by telephone or by fax.

In a preferred embodiment, the Retailers store in their databases the digital coupon templates and information necessary to link to the Manufacturer for verification. Such information includes but is not limited to the URL for redemption of the template.

Coupon Download

In our preferred embodiment, digital coupons are passed in binary format.

The coupon can be accessed directly from the browser through hyperlink (URL) referring to a program in charge of dynamic creation of the digital coupon by the coupon server.

As one of ordinary skill will appreciate, it is then possible to embed access to the coupon through an image such as a banner.

From this aspect, it follows that it is possible for an Internet user to click on a banner displaying a description of a digital coupon.

Such banner contains a link to the digital coupon server with information concerning the template passed through the GET method.

It is also possible to access a digital coupon after a purchase has been made, or as the result of a promotional offer. A hyperlink to the creation of digital coupon can be installed anywhere.

Using this information, the digital coupon server is able to instantiate the corresponding digital coupon. This digital coupon is then sent back to the user's browser through a selected MIME type (such as application/x-ca-digitalcoupon) along with registration URL. The Registration URL (specified in the header part of the document with a X-Registration field) indicates what is the corresponding digital coupon serial number.

The browser passes all that information to the digital coupon book which is registered on the user's system to treat such corresponding MIME types.

Once the digital coupon is stored on the user's hard drive, the Digital Coupon Book contacts the Digital Coupon Server at the given Registration URL to inform that the digital coupon was correctly received and stored on the user's hard drive, and also to inform the server about the user's Member Identifier.

The Digital Coupon Server updates the user's information to its database.

In an alternate embodiment, no information regarding the user's Member Identifier is sent back to the Digital Coupon Server.

The digital coupon is saved as a file on the user's hard drive with an explicit filename extension (such as .cpn). The digital coupon book may present the user with a choice of a category where that digital coupon should be saved. The use of categories gives the user more power for managing a selection of coupons from various retailers, and it is the main reason for a Digital Coupon Book.

Coupon Management

A method is described to allow Internet users to manipulate digital coupons. The term manipulation allows the user to:

Delete digital coupons

Verification of digital coupons

Change the digital coupons names

Move digital coupons to another category

Create/Delete/Rename categories

List digital coupons corresponding to a specific category or to a specific merchant

Searching for specific digital coupons

In a preferred embodiment, the digital coupon refers to a file. The name of the file is the name of the digital coupon, a category (such as “pets products”) refers to a directory name, and a merchant name is referenced by a directory as well.

It is, therefore, possible to apply changes through the file system without being architecture dependant.

It is possible to transfer digital coupons to other Internet users by email or any other network means.

Also, it is possible to make a repository of digital coupons available to Internet users through the creation of an FTP or Web server.

In one embodiment where the digital coupons serial number uniqueness is not verified during redemption, it is possible for Internet users to transfer them to other Internet users without risk of losing the benefit of the discount for themselves (assuming other conditions such as the end of validity period are O.K.).

In an alternate embodiment, however, where the serial number is verified on the server at redemption, such transfer will increase the chances that somebody else redeems the given digital coupon first. Since uniqueness of the coupon is guaranteed during redemption, only the first user will be able to successfully redeem the digital coupon. A system is, therefore, described to help users recognize whether digital coupons are non serialized (in the sense that the serial number is not verified) or serialized (uniqueness of the digital coupon is verified).

The serial number of the first type of digital coupons ends up with 0000, which makes them easily recognizable both on the server side and on the client side.

The verification of a coupon on the client side is an important part of the trust system between Manufacturers, Retailers and Internet users.

Using the public key of the image embedded in the data part of the digital coupon, it is possible to verify the authenticity of the image.

It is also possible to verify the digital signature of the digital coupon file, which is a necessary step to make sure that the digital coupon has not been altered in some way.

Full verification of the digital coupon also includes confirmation from the entity that created it.

In an embodiment of the system, it is possible to verify digital coupons by making a call to the digital coupon server with the public key and the serial number of the digital coupon.

The serial number containing the SNTemplate and the public key are matched by the digital coupon server on its database of templates.

If an occurrence with the same public key and the same serial number is found within the database, then it is proof that the corresponding digital coupon has really been instantiated by this digital coupon server.

The verification of a digital coupon is subject to DNS spoofing where the Internet user believes the Manufacturer digital coupon server to be some Web site, but is, in fact, redirected to another Web site.

A method is proposed to make sure that the verification process is not subject to DNS spoofing: the verification process should take place over an SSL connection.

An embodiment of the system provides a way to search for digital coupons on the basis of keywords. A solution is provided on the user's application, the digital coupon that allows for search on a directory of digital coupons using keywords. These keywords are then matched against a database of digital coupons templates. Descriptions of Digital coupon templates matching the query are returned to the user's digital coupon book, where an instance of that digital coupon can later be saved.

Specifications Regarding the Discount Rules

A method is given to express a discount mechanism in a short, precise and extensible way.

Discount rules are expressed using Name=Value expressions. They include, but are not limited to, the following expressions:

A: amount of the discount. This amount represents a percentage or a nominal reduction fee. A=12; T=P represents a 12% reduction. It is a required parameter (although it is not strictly required if the discount is one where a product is given when several other are purchased).

T: type. The discount type. It can be P (percentage), N (nominal) which is an amount in money, or B (bundle) which indicates that the discount is applied if other products of the same type are purchased.

It is a required parameter and, thus, has no default value.

C: currency of the discount. Currency is expressed in international ISO code. For example USD for American dollars, and FFR for French Francs. The default if not expressed is the Retailer's web site own default currency.

Q: quantity. For example in “buy 3 apples, get 1 free!” would be expressed as: Min=3; Q=1; T=B.

There is no default value.

CUMUL: cumulative. Indicates whether the digital coupon discount is cumulative with other discounts. The Max parameter (see below) indicates the maximum number of cumulative Digital Coupons discounts that may be applied.

Values are Y (yes) or N (no). Default value is Y.

Min: minimum. Indicates the minimum number of products or the least amount of money that needs to be spent before the discount applies.

Max: maximum: indicates the maximum number of digital coupons that can be redeemed during the same buying process. The default is there are no limits.

CAT: category. Indicates if the discount is applicable to the product ID that is mentioned in the coupon (P), or to any purchase within the store (G).

An example of such a discount rule might be: T=N; A=8; Min=100; CUMUL=N; C=USD; Cat=G

Which means: “Apply a $8 discount on any purchase of $100 or more on the store. This discount is not cumulative”.

If an identifier is not needed, it won't be part of the discount rules, which implies that discount rules will be kept as small as possible.

Redemption of a Coupon

The system includes a way for a user to redeem a coupon and, thus, take advantage of a discount during shopping at an online shopping center.

A typical redemption session is built upon 3 consecutive steps:

Verification: tests are performed to ensure validity of the digital coupon.

Locking: the digital coupon is valid and inserted within a user's session, but the buyout process has not been completed by the Internet user.

Redeem: the digital coupon has been taken into account at checkout and is not valid anymore.

In a preferred embodiment of the system, software at the client machine, namely the digital coupon book is used to verify that the date of the end of validity of the digital coupon has not been exceeded.

If the date of validity is not correct, a warning message is sent back to the user and the corresponding digital coupon is sent to the trash.

In the case where the Manufacturer is also a Retailer, only one URL will be available for redemption. However, if the Manufacturer is distinct from the Retailer, and several Retailers have been selected who all accept the corresponding digital coupon, then the user has to select a URL corresponding to its Retailer of choice.

From this information, the Digital Coupon Book creates an HTML page containing a form to be sent back to the redeem URL. This form contains the unencoded data part of the Digital Coupon, as well as the user's member Identifier.

Session information on the client side can be derived from a Cookie or from a Session ID that is kept within hidden fields of a form or inside the URL used to access a merchant Web site.

If the user is in the middle of a communication session with the merchant, then session identification is associated with the user. This information is then included in the form as well.

All fields of the form are “hidden”, i.e., they are not directly visible on the display of the HTML page.

In a preferred embodiment, this form is launched automatically using Javascript, or any other client application language. If the Internet user has disabled all client application language, he will have to manually validate the form by clicking a button. The form is sent to the selected redemption URL along with the user's Member Identifier, and session information.

Once the form has been sent, the digital coupon file on the user's file is moved to a specific directory where redeemed digital coupons are stored.

In our preferred embodiment, this coupon is not removed from the system, although if it is valid and the buying process ends up successfully, it may not be valid anymore.

The redeem URL calls the MS-Session Manager application on the Merchant system which is interfaced both to the Merchant server application and the digital coupon server.

A method is included that allows the MS-Session to undecode the data part of the digital coupon, and update the user's session information on the merchant server, whether this information is stored in a file, on a database server, or in the merchant server's memory.

The MS-Session Manager also acts as a proxy for the digital coupon server. The MS-Session Manager first examines the digital coupon serial number. If this digital coupon is “serialized”, then it queries its own hash table to know whether a digital coupon with the same digital number has already been redeemed. If this is the case, an error message is sent back to the user through an HTML page. Otherwise, an entry with this serial number is written to the hash table.

If the serial number is valid for redemption, a Corba session is opened from the MS-Session Manager to the Digital Coupon Server and the whole data part along with the user's Member Identifier is sent to the Digital Coupon Server.

The Digital Coupon Server starts by making verifications about the date of start and end of validity concerning the digital coupon. If the current date does not fit within these two dates, an error message is sent back through the Corba session, and displayed by the MS-Session Manager.

If the date is still valid, the Digital Coupon Server looks at the SNTemplate which is part of the digital coupon serial number. If the digital coupon has been created by this Retailer (i.e., this Retailer is also the Manufacturer of the digital coupon), then verification takes place using the own templates database of the eKoopon Server.

Otherwise, verification takes place using templates information given by the Manufacturer. Such information includes the template's public key which is mandatory to verify the digital coupon structure.

In this embodiment of the solution, it is mandatory that all necessary information regarding the digital coupon template be included in the database of the digital coupon server. Although it would be possible for each digital coupon verification to query the remote database of the original manufacturer, such action would not be practically possible, considering the speed requirements due to the real time constraints associated with the redemption process.

If the information extracted from the local database system happens to be missing or is incomplete, an error message is sent back to the MS-Session Manager, advising the Internet user that this Retailer site is not ready to accept the digital coupon created by the specific Manufacturer.

The verification process includes a step to make sure that the maximum number of available digital coupons for redemption has not been reached. If the maximum number of digital coupons for this specific template has already been reached, an appropriate error message is sent back to the MS-Session Manager, and the status flag is set accordingly for the template in the database.

It includes a step to verify that the status of a specific digital coupon template allows the redemption process to take place. If, for any reason, the redemption process has been forbidden by the Merchant Server administrator or made invalid by any other verification process, an appropriate error message is sent back to MS-Session Manager.

It includes a step to make sure that the digital coupon serial number is not in a Locked or Released position. If the Digital Coupon has been in a Lock state for more than 30 minutes without a change of state, it goes back to Verification state again. Otherwise, an appropriate error message is sent back to the MS-Session Manager.

It includes a step to make sure that the same digital coupon is not verified several times by the same IP address if the digital coupon policy forbids this.

It includes a step to verify the digital signature of the digital coupon. The public key embedded in the coupon data is matched against the public key in the coupon data. This key is then used to decrypt the digital signature and compare it to the hash resulting from the data part of the digital coupon.

If all these steps are performed successfully, the digital coupon goes into a “locked” state: the digital coupon server waits for redemption confirmation from the MS-Session Manager. The database for the digital coupon is updated.

If the coupon has been created by a digital coupon server from a specific Manufacturer, it is mandatory to lock the coupon on the system so that two different retailers cannot lock the same digital coupon twice.

In this embodiment, a query for locking is sent to the Manufacturer digital coupon server containing information to be kept in the database including the Member Identifier of the person who redeems the coupon.

The Manufacturer digital coupon server updates the information in its redemption database and sends back to the Retailer digital coupon server the confirmation that the digital coupon server has been locked or a signal that it cannot be locked (for a reason such as the fact that it as already been successfully redeemed by another retailer).

Once locked, the digital coupon server sends a validation message to the MS-Session Manager, which in turns computes the discount through the set of rules contained in the Discount Rules. The “discount rules” is an extensible set of coded specifications that specify what sort of reductions are embedded in the Digital Coupon and how they should be expressed corresponding to the present situation.

The updated price, taking the Discount Rules into consideration is written back to the session mechanism in use through the merchant site.

A digital coupon will be considered locked as long as the buyout session has not been completed or that a given timeout has not expired, which leaves the Internet buyer enough time to continue shopping on the merchant Web site.

This timeout may be specified on a per template basis by the Merchant Administrator during the creation of the template. If the timeout expires, and the digital coupon has not been redeemed, it goes back to a state where it is available.

A digital coupon is considered redeemed once the buyout session has been completely achieved, which usually involves transmission by the Internet user of banking information.

Some specific Web sites, such as Amazon allow a transaction to take place without transmission of banking information through, for example, the “One-Click” shopping process.

Once the buyout process is completed from both the merchant and user's point of view, a call to the URL of the MS-Session Manager is made generally through the use of an HTML page.

The Session Manager then updates the digital coupon server with information regarding the buyout process.

Information collected by the Digital Coupon Server during this confirmation step includes but is not limited to the amount of products bought, the user's session identifier, and the user's IP address as well as the current date and time.

All this information is stored in a database, to allow further analysis by the Digital Coupon Manager.

Whether or not the digital coupon was redeemed successfully, if the Manufacturer digital coupon server is not the same as the Retailer digital coupon server, then an update query has to take place on the Manufacturer digital coupon server. A locked digital coupon will be freed again (if the timeout has expired). A digital coupon successfully redeemed on the merchant Web site will be marked as redeemed on the Manufacturer database.

Analysis of the Information by a Digital Coupon Manager

The Digital Coupon Manager includes functionality to analyze the Coupon Policy and make statistical reporting about the user's habits and buying patterns.

A method is provided to correlate the information collected during the download and redemption process, especially the Members Identifiers, with information that members of the system specify when they register the use of their Digital Coupon Book.

The accumulation of information makes it possible to specify usage of digital coupons by age, gender, marital status, occupation, and other statistical information, and to create the average statistics for a merchant web site for every digital coupon template.

1. A method of creating and signing digital representations of uniquely identified coupons for a plurality of users comprising:
providing a digital coupon having a serial number, information about a manufacturer, a date of start of validity, a date of end of validity, specific location information for redemption, association with a product or a range of products, information about the product being discounted, discount rules including, but not limited to, amount, currency and type of discount; and
embedding a digital signature in the coupon.

2. The method of claim 1, wherein the redemption information is a URI or a range of URI.

3. The method of claim 1, wherein the digital coupon is divided in two parts, a first part being digital coupon data containing information about the nature of the discount, and a second part being an image that can be displayed over the Internet, or through other media.

4. The method of claim 1, wherein the digital coupon is divided into an image part and a data part, each part being protected by a digital signature using a hash algorithm and a public/private key pair, and wherein the digital signature is embedded in the data part.

5. The method of claim 1, wherein discount information is associated with a product, a range of products, or whole contents of a shopping cart generated by a customer.

6. The method of claim 1, wherein discount information is expressed inside an independent structure of the data contained in the digital coupon.

7. The method of claim 1, wherein discount amount and type may be dependent on various parameters such as digital coupon lifespan.

8. A method of distributing Digital Coupons over the Internet or over any network using a client and server mechanism comprising:
generating a coupon file;
signing the digital coupon file; and
sending the digital coupon to a selected recipient through an Internet protocol.

9. The method of claim 8, wherein digital signature of the coupon takes place in real time, as coupons are requested from the recipient.

10. The method of claim 8, wherein digital coupons are created, digitally signed and stored as files in advance on a digital coupon server.

11. The method of claim 8, wherein a server sends back to the recipient information for registration of the digital coupon download.

12. The method of claim 11, wherein the protocol in use for communication between the recipient and the server is HTTP.

13. The method of claim 8, wherein a template for the digital coupons is propagated to another digital coupon server Retailer authorized to make reductions by a digital coupon Manufacturer.

14. The method of claim 11, wherein the protocol in use for communication between the recipient and the server is SSL over HTTP.

15. The method of claim 8, wherein a server application embodies information provided by a user such as a password to allow verification of the user's claimed ownership of the Digital Coupon at redemption.

16. The method of claim 8, wherein each recipient application is uniquely identified.

17. The method of claim 8, wherein the recipient receiving the Digital Coupons is a browser used to navigate on the Internet.

18. The method of claim 8, wherein Digital Coupons are distributed through a banner ad.

19. The method of claim 8, wherein Digital Coupons are moved using floppy disks or any other kind of information medium, independently of any interaction with a server used for creation.

20. A method for a user to verify integrity and validity of a selected Digital Coupon at any selected time comprising:
presenting to a server responsible for Digital Coupon information relevant to price reduction;
obtaining a confirmation of validity;
generating an error message; and
sending the error message to the recipient if the Digital Coupon is not valid.

21. The method of claim 20, where an authentication takes place between the recipient and the server, to verify that the server really is who it claims to be.

22. The method of claim 20, where an entity that accepts the digital coupon is not the same as an entity that created it.

23. A method for a user to redeem a Digital Coupon at a desired moment of a buying process comprising:
verifying by a coupon server validity of a specific coupon;
storing information regarding said Digital Coupon in a database;
subtracting a price of an item being ordered from the discount specified in the Digital Coupon; and
generating an order regarding the purchase made by the user.

24. The method of claim 23, wherein coupon redemption occurs at the beginning of a transaction or after a purchase order has been made.

25. The method of claim 23, wherein redemption information is propagated to a manufacturer of the Digital Coupon using CORBA.

26. The method of claim 23, wherein the user redeeming a Digital Coupon is uniquely identified.
